(19) United States
(12) Patent Application Publication
(10) Pub. No.: US 2026/0178974 A1
(43) Pub. Date: Jun. 25, 2026

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Akane ISEKI, Kanagawa (JP)

(21) Appl. No.: 19/373,870

(22) Filed: Oct. 30, 2025

(30) Foreign Application Priority Data
Nov. 5, 2024 (JP) 2024-193959

(51) Int. Cl. G06N 20/00

(52) U.S. Cl. CPC G06N 20/00

(57) ABSTRACT

A first obtaining unit obtains a first generated result via input of first input information into a first machine learning model. A second obtaining unit obtains a second generated result via input of the first input information into a second machine learning model different from the first machine learning model. A detecting unit detects a first variation of an item that varies depending on a difference in machine learning models used in generation between the first generated result and the second generated result. A first generation unit generates, based on the first variation, first auxiliary information including information for changing input information to be input into the second machine learning model from the first input information in a case where the first variation is detected.

### BACKGROUND

### Field of the Technology

The present disclosure relates to an information processing apparatus, an information processing method, and a storage medium.

### Description of the Related Art

One definition of generative AI, a major trend in recent artificial intelligence (AI) technology, is technology for generating new data not in the pre-training data in response to an input such as a text prompt using a deep neural network (DNN) trained in advance. Generative AI is developing at a fast speed supported by the development of deep generative models and multimodal-based models. Recent deep generative models such as diffusion models can generate data of an extremely high quality. Also, multimodal-based models such as Contrastive Language-Image Pre-training (CLIP, Learning Transferable Visual Models From Natural Language Supervision, Radford et al., ICML2021) has high zero-(few-) shot performance, allowing for association of different modalities, such as association between language and an image, to be performed at a high performance.

Generative AI tasks include various types of generating an output Y from an input X, and these tasks are called X-to-Y tasks. By using an X-to-Y task, conversion between various modalities such as generation of content such as images, videos, and 3D data using language, image style conversion, and the like can be performed at a high performance. Tasks with a text prompt as the input include Text-to-Image, Text-to-Video, Text-to-3D, and similar tasks for generating any image, video, or 3D data as instructed by a user. Image-to-Image tasks such as image style conversion, Inpainting, and the like are also examples.

A large difference between such generative AI tasks and traditional AI is, for example, the high practical utility that allows anyone, by interacting in a natural language, to generate high quality creative content. With prompt engineering, it is easier to obtain a desired image without re-training the model.

Generative AI services have rapidly increased in number due to this high practical utility, and services with novel functions taking insight from the rapid development of the technology are appearing one after another. In such a hectically shifting market, frequently releasing a version update of a model is one important measure for producing a better service.

A user of generative AI may spend a large amount of time adjusting the input such as a text prompt in order to obtain a desired image. However, when the model being used changes, such as the before and after of a version update of an X-to-Y model, in some cases, the “taste” of the generated results obtained from the same input may be different. In a situation where the old model cannot be used due to the release of a version update, if a user were to try to newly generate a generated result Y with a taste similar to that of the generated result Y generated previously using the old model, the user may spend a significant amount of time re-adjusting the prompt.

### SUMMARY

The present disclosure provides an information processing apparatus that, even in the case of the user using a different model to the model previously used, makes it easier to obtain a generated result similar to the generated result of the previously used model.

According to one embodiment of the present disclosure, an information processing apparatus comprises: a first obtaining unit configured to obtain a first generated result via input of first input information into a first machine learning model; a second obtaining unit configured to obtain a second generated result via input of the first input information into a second machine learning model different from the first machine learning model; a detecting unit configured to detect a first variation of an item that varies depending on a difference in machine learning models used in generation between the first generated result and the second generated result; and a first generation unit configured to generate, based on the first variation, first auxiliary information including information for changing input information to be input into the second machine learning model from the first input information in a case where the first variation is detected.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIGS. 1A, 1B, and 1C are block diagrams illustrating an example of the hardware configuration of a system including an information processing apparatus.

FIGS. 2A and 2B are block diagrams illustrating an example of the functional configuration of an information processing apparatus according to a first embodiment.

FIGS. 3A and 3B are flowcharts illustrating an example of information processing according to the first embodiment.

FIGS. 4A, 4B, and 4C are diagrams for describing examples of detection of variation in an object.

FIG. 5 is a block diagram illustrating an example of the functional configuration of an information processing apparatus according to a second embodiment.

FIGS. 6A and 6B are flowcharts illustrating an example of information processing according to the second embodiment.

FIGS. 7A and 7B are flowcharts illustrating an example of information processing according to a third embodiment.

FIGS. 8A, 8B, 8C, 8D, and 8E are diagrams for describing lists generated according to detected objects.

FIGS. 9A, 9B, 9C, 9D, 9E, 9F, 9G, 9H, 9I, 9J, 9K, and 9L are diagrams for describing examples of detection of variation in the color of an object.

FIG. 10 is a diagram for describing an example of a database of generation history information.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

An information processing apparatus according to the present embodiment obtains a first generated result and a second generated result as output for input corresponding to first input information including text information for a first machine learning model and a second machine learning model. Next, the information processing apparatus detects variation in an item that varies depending on the machine learning model used in generation between the first generated result and the second generated result. In a case where such a variation is detected, the information processing apparatus generates auxiliary information for use in changing the input information of the second machine learning model from the first input information on the basis of the detected variation. Such an information processing apparatus will be described below.

With an X-to-Y task, in a case where the machine learning model being used is changed due to a version update or the like, the generated results Y for the same input X may vary. Here, in such a case, the user is recommended to change the X for assisting in obtaining a similar generated result. Hereinafter, a machine learning model that performs an output with respect to an input may be simply referred to as a “model”, and when the input X and output (generated result) Y are simply described, this means they are the input/output of such a model.

In the present embodiment, the input X input to the model includes text information such as a text prompt. Also, the input X may further include other information such as a style image, a configuration image, bounding box (BB) information designating a layout, or the like. The data type (modality) of the generated result Y output by the model is not particularly limited and may be an image, a video, 3D, or the like, for example. In the example described below, the model according to the present embodiment performs a text-to-image task with text information as input and image data as output.

Examples of variation items that vary between the generated results Y depending on the model used even with the same input X include a change in the color of the image, objects forming the image, the configuration (position or size of objects and positional relationship of objects), the degree of blur, and the like. In the example of the present embodiment described here, a change of objects forming the image is detected as the variation item.

### Hardware Configuration

In the first embodiment described here, it is assumed that each item of processing is executed using a system including a user equipment connected to a network and a server providing a service. The information processing apparatus according to the present embodiment is implemented as a server 103 providing the service.

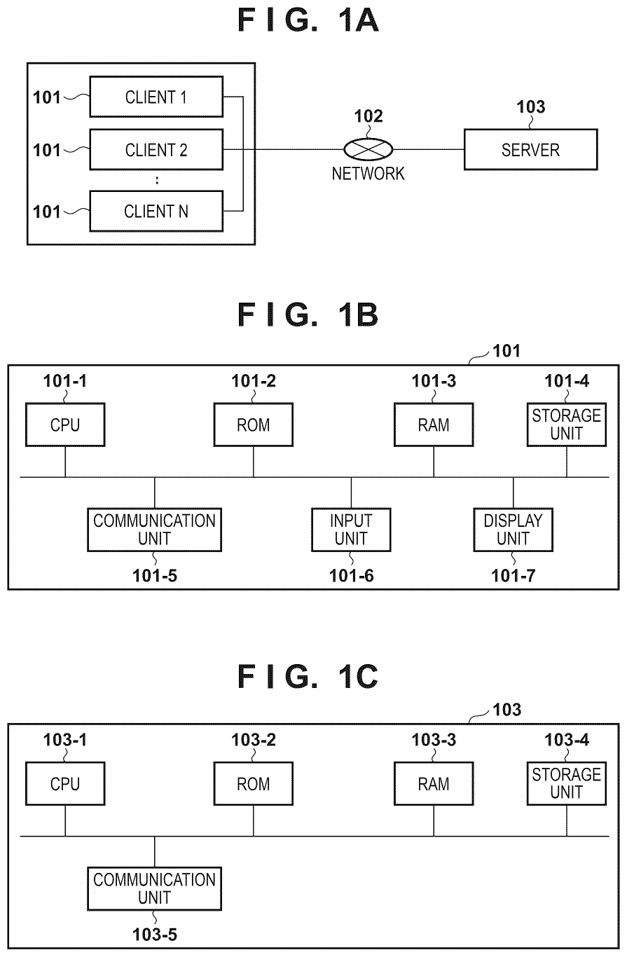

FIG. 1A is a diagram illustrating an example of the configuration of a system including the server 103 according to the present embodiment. The server 103 is connected to a client (user equipment) 101 via a network 102.

FIG. 1B is a block diagram illustrating an example of the hardware configuration of the client 101 according to the present embodiment. The client 101 includes a CPU 101-1, a ROM 101-2, a RAM 101-3, a storage unit 101-4, a communication unit 101-5, an input unit 101-6, and a display unit 101-7. Each component element is connected via a system bus.

A CPU 101-1 controls the entire apparatus by executing a control program stored in a ROM 101-2. The RAM 101-3 temporarily stores various types of data from the component elements. Also, the RAM 101-3 is where a program is loaded and put in an executable state for the CPU 101-1. The storage unit 101-4 stores the data to be processed by the server 103 according to the present embodiment and stores generation history information and temporarily stores the data generated in the information processing. The generation history information is information including input information such as text prompts used by the user to generate data, model information representing which model used, and generated results. Examples of mediums that can be used as the storage unit 101-4 include HDD, flash memory, various types of optical media, and the like. The communication unit 101-5 performs the communication between the client 101 and the server 103 via the network 102. The input unit 101-6 receives an input such as a text prompt from the user. The display unit 101-7 displays input for a model, generated results, previous generation history information, auxiliary information for changing prompts by the system, and the like.

FIG. 1C is a block diagram illustrating an example of the hardware configuration of the server 103. The server 103 includes a CPU 103-1, a ROM 103-2, a RAM 103-3, a storage unit 103-4, and a communication unit 103-5. Each component element is connected via a system bus. The CPU 103-1, the ROM 103-2, the RAM 103-3, the storage unit 103-4, and the communication unit 103-5 can have a similar configuration to the CPU 101-1, the ROM 101-2, the RAM 101-3, the storage unit 101-4, and the communication unit 101-5, and thus the functions will not be described here.

Note that the client 101 may be provided with a piece of hardware specializing in AI processing such as a graphics processing unit (GPU), a tensor processing unit (TPU), or an AI-processing-dedicated chip for performing deep neural network (DNN) processing at high speeds. The same applies to the server 103.

### Processing Contents

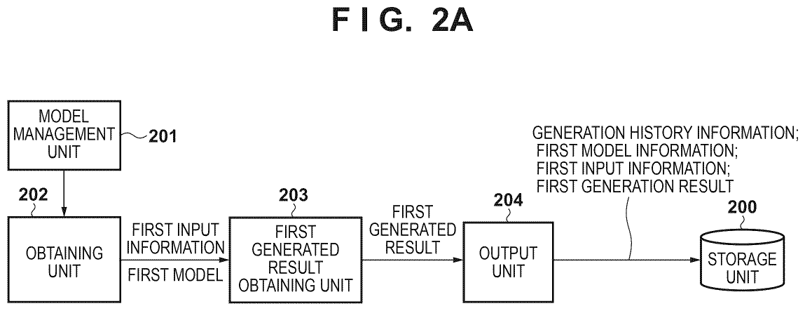

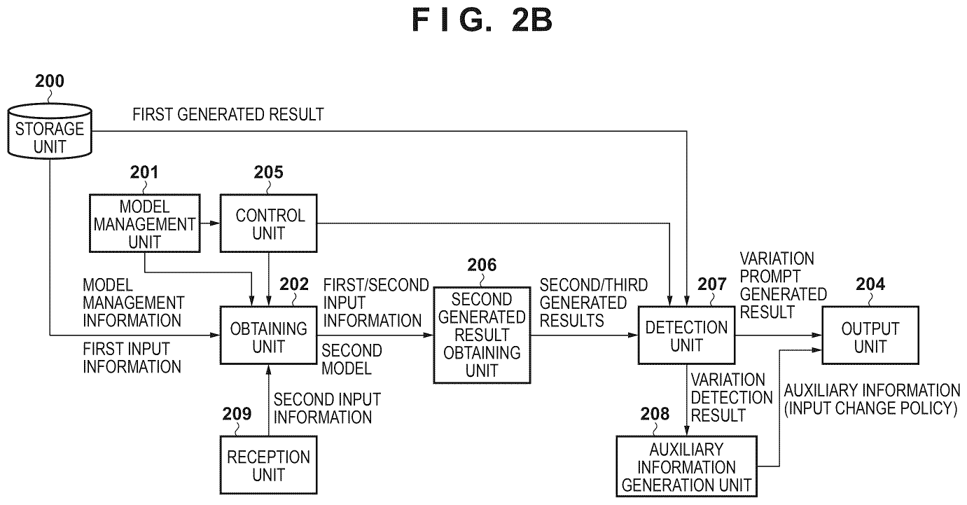

FIGS. 2A to 2B are diagrams illustrating an example of the functional configuration of the server 103 according to the present embodiment. The server 103 includes a storage unit 200, a model management unit 201, an obtaining unit 202, a first generated result obtaining unit (first result obtaining unit) 203, an output unit 204, a control unit 205, a second generated result obtaining unit (second result obtaining unit) 206, a detection unit 207, an auxiliary information generation unit 208, and a reception unit 209.

In the present embodiment, the first input information corresponding to the same input information is input into the first machine learning model and the second machine learning model different from the first machine learning model. Here, as the second machine learning model, a version updated version of the first machine learning model is used. FIGS. 2A and 2B illustrate the flow of data between functional units in the model before the update (pre-update model) and the model after the update (post-update model). An example of the first image generation processing (a) executed when the first input information is input into the pre-update model and second image generation processing (b) executed when the first input information is input into the post-update model will be described below.

### First Image Generation Processing (a)

Here, processing executed by each functional unit provided in the server 103 relating to the first image generation processing (a) will be described. The storage unit 200 stores generation history information and a model. The storage unit 200 according to the present embodiment stores a plurality of models, and one of these is used in the subsequent processing as the processing target model. The model management unit 201 manages information indicating the version of the models stored in the storage unit 200 and information indicating whether a model will be used by a user. Hereinafter, this information managed by the model management unit 201 may also be referred to as “model management information”.

The obtaining unit 202 obtains the input information input into the first model as the first input information. The first input information according to the present embodiment is a text prompt. The obtaining unit 202 may obtain the first input information on the basis of information that the user input into the input unit 101-6 (or via the reception unit 209 described below, for example). Here, the obtaining unit 202 can obtain the model management information from the model management unit 201 and can obtain a model that the user is allowed to use from among the models stored in the storage unit 200 as the first model on the basis of the model management information. Note that the user executing the processing is identified via login processing or by identifying the connected client.

The first result obtaining unit 203 inputs the first input information obtained by the obtaining unit 202 into the first model and obtains an output for the input as the first generated result.

The output unit 204 outputs the first generated result obtained by the first result obtaining unit 203 as the generation history information together with the input information such as the text prompt used in data generation and the model information representing what model was used in data generation, and the storage unit 200 stores the output. Also, the output unit 204 may output the generated result, generation history information, or the like to a display apparatus such as the display unit 101-7.

### Second Image Generation Processing (b)

Next, processing executed by each functional unit provided in the server 103 relating to the second image generation processing (b) will be described. The control unit 205 controls the operations of the obtaining unit 202 and the detection unit 207 on the basis of the model management information. Specifically, in a case where the model is version updated from the first model to the second model, the control unit 205 can control each functional unit so that the first input information and the second model are obtained and the second generated result is generated.

The obtaining unit 202 obtains the second model. Here, the obtaining unit 202 can obtain the model management information and can obtain the second model, which is an updated model of the first model, on the basis of the model management information.

The second result obtaining unit 206 inputs the first input information obtained by the obtaining unit 202 into the second model and obtains an output for the input as the second generated result. Also, the obtaining unit 202 can obtain second input information (described below) obtained by changing the first input information, and the second result obtaining unit 206 can obtain a third generated result from the second input information being input into the second model.

The detection unit 207 detects variation between the first generated result and the second generated result of an item (variation item) that varies depending on the difference in the models used in the generation. Here, as the variation item, an item that varies depending on the version update of the model is used, and this variation item is set in advance. The variation item will be described below in detail, but for example, in a case where the “number of objects” is set as the variation item, variance is detected for the number of predetermined objects corresponding to detection targets included in each output. Note that the number of variation items is not particularly limited, and one or a plurality may be set.

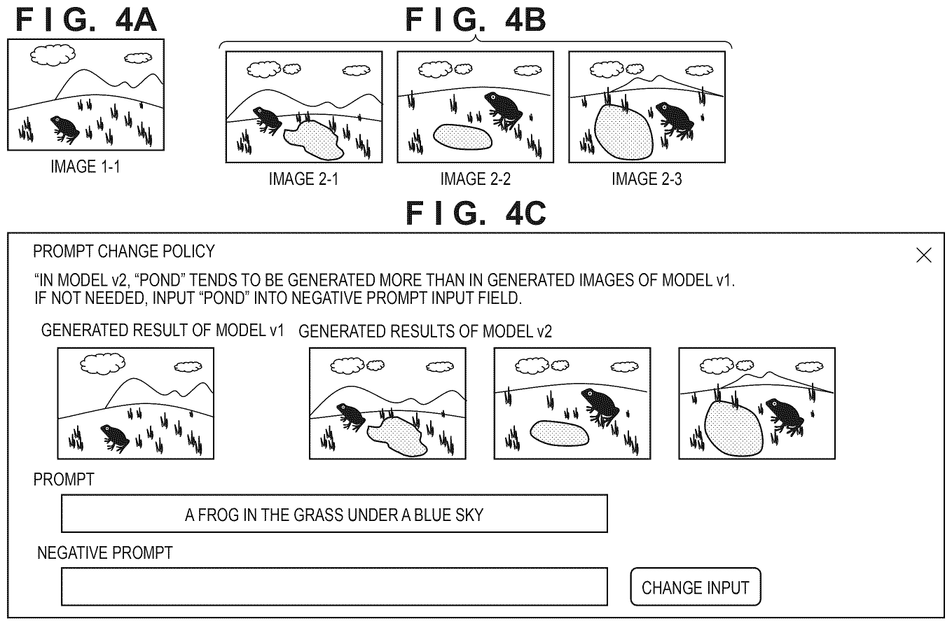

The auxiliary information generation unit 208 generates auxiliary information when variation is detected on the basis of the variation detection result detected by the detection unit 207. The auxiliary information according to the present embodiment is information generated on the basis of the variation detected by the detection unit 207 and includes information for changing the input information input into the second model from the first input information. Here, the auxiliary information generation unit 208 can generate the auxiliary information as information for making the variation between the first generated result and the third generated result obtained by inputting the second input information changed from the first input information on the basis of the auxiliary information into the second model less than the variation between the first generated result and the second generated result. In particular, as auxiliary information, information indicating the change policy of the input that assists in how to change the first input information is used in order to obtain a generated result similar to the first generated result when the second model is input with the first input information. As auxiliary information, for example, text information prompting for a reduction in the variation between the first generated result and the second generated result can be used, and this will be described below in detail with reference to FIGS. 4A to 4C and the like. The auxiliary information is presented to the user via a display on the display unit 101-7.

The reception unit 209 receives an input from the user after the generation of the auxiliary information and the presentation to the user. Next, the reception unit 209 generates the second input information on the basis of the first input information and the user input received after the presentation to the user. The second input information is stored by the storage unit 200.

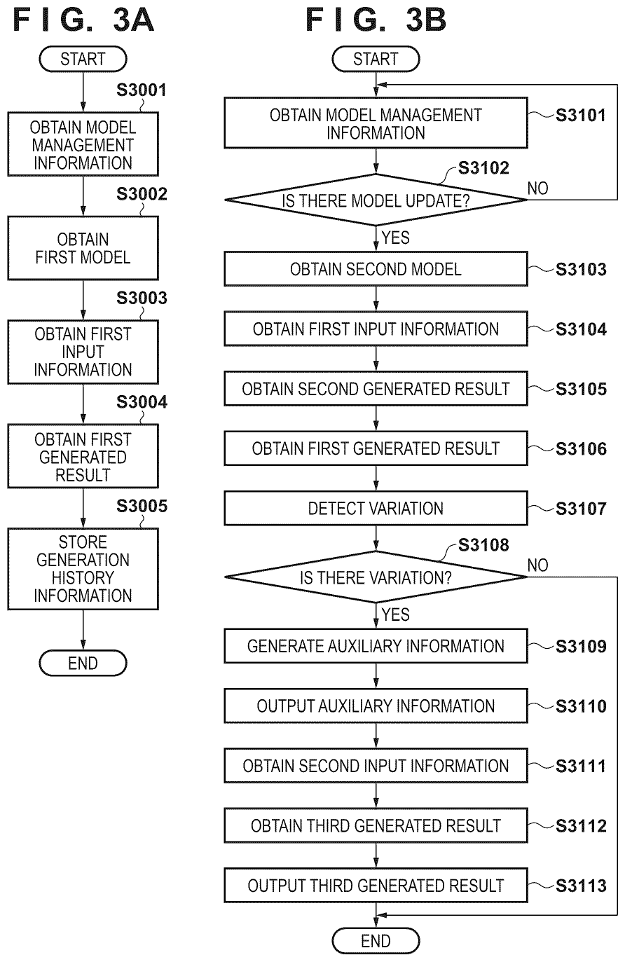

An example of the information processing executed by the server 103 according to the present embodiment will be described below with reference to FIGS. 3A and 3B. The processing illustrated in FIGS. 3A and 3B is an example, and all of the processing described using the flowchart is not necessarily executed by the server 103. The flowchart of FIG. 3A illustrates the processing (first image generation processing (a)) by the first model, and the flowchart of FIG. 3B illustrates the processing (second image generation processing (b)) by the second model.

### Processing by First Model

FIG. 3A is a flowchart illustrating an example of the processing in a case where the first image generation processing (a) is executed using the first model. The processing illustrated in FIG. 3A is executed in a case where image generation execution processing is received from the client 101 on the basis of a user input, for example.

In S3001, the obtaining unit 202 obtains the model management information. Here, the model management information includes a list of the models that can be used by the current user and the version information of the models.

In S3002, the obtaining unit 202 obtains a usable model as the first model on the basis of the model management information obtained in S3001.

In S3003, the obtaining unit 202 obtains the first input information. Here, the obtaining unit 202 may obtain, via the reception unit 209, a text prompt input to the input apparatus by the user as the first input information.

In S3004, the first result obtaining unit 203 obtains the first generated result by inputting the first input information obtained in S3003 into the first model. A plurality of the first generated results may be generated using different random number seed values or one may be generated.

In S3005, the output unit 204 outputs the first generated result obtained in S3004 as the generation history information together with the input information such as the text prompt used in the data generation and the model information indicating which model was used in the data generation, and the processing ends. Here, the storage unit 200 stores the generation history information. The generation history information may be displayed on a display apparatus (for example, the display unit 101-7 provided in the client 101) or may be displayed together with other information such as the input information, the model information, or the like.

### Processing by Second Model

FIG. 3B is a flowchart illustrating an example of the processing in a case where the second image generation processing (b) is executed using the second model. The processing illustrated in FIG. 3B is executed in a case where image generation execution processing is received from the client 101 on the basis of a user input, for example. Also, the processing illustrated in FIG. 3B may be executed periodically, for example, or may be executed when the user issues a start instruction.

In S3101, the obtaining unit 202 obtains the model management information for each model. Here, the model management information includes information of the date and time of the version updates of each version for each model.

In S3102, the obtaining unit 202 confirms whether or not there is a model with an update. In a case where a model has been updated, the processing advances to S3103. Otherwise, the processing returns to S3101.

The processing for confirming whether or not a model has been updated can be executed by any method for detecting model updates. For example, in the processing loop of S3101 to S3102, the model management information obtained in S3101 in the previous loop and the model management information obtained in S3101 of the current loop are compared, allowing the obtaining unit 202 to confirm whether or not the model has been updated. Also, for example, the obtaining unit 202 may record information indicating the latest model included in the model management information in a case where a model update is confirmed, and in a case where the version confirmed in S3102 is not the recorded version, the version is determined as an updated model. Also, the loop of S3101 to S3102 may be performed each time confirmation is performed for whether or not there has been an update for all of the managed models or may be performed individually for each model.

In S3103, the obtaining unit 202 obtains the updated model as the processing target model or as the second model and further obtains the generation history information of the model.

In S3104, the obtaining unit 202 obtains the first input information input into the pre-update model of the processing target model on the basis of the generation history information obtained in S3103.

In S3105, the second result obtaining unit 206 obtains the second generated result obtained by inputting the first input information obtained in S3104 into the second model. A plurality of the second generated results may be generated using different random number seed values or one may be generated.

In S3106, the detection unit 207 obtains the first generated result, which is the result of inputting the first input information into the first model. Here, the detection unit 207 obtains the first generated result included in the generation history information obtained in S3103, but the data corresponding to the first generated result may be input via a user operation.

In S3107, the detection unit 207 detects variation in the variation item between the generated results on the basis of the second generated result obtained in S3105 and the first generated result obtained in S3106 and outputs the variation as a variation detection result.

An example in which variation in the objects forming an image is detected as the variation item will be described below with reference to FIGS. 4A to 4C. FIGS. 4A and 4B illustrate the first generated result and the second generated result, respectively. Here, the first generated result and the second generated result are images generated by inputting a text prompt of “a frog standing in the grass under a blue sky” is input into the model as the first input information. FIG. 4B illustrates three different types of images generated by the second result obtaining unit 206 using different random number seed values (for example, in S3105) as the second generated results. In this manner, the second generated result may be a plurality or only one may exist.

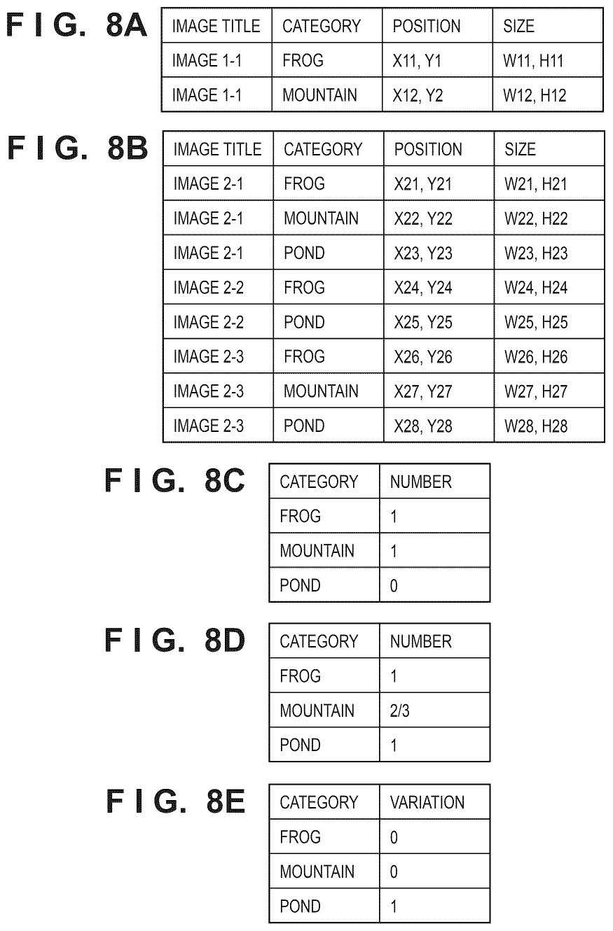

The detection unit 207 first uses an object detector for detecting an object to be detected from the image using a DNN or the like and detects an object in the image from the first generated result and the second generated result. Next, the detection unit 207 outputs the detected object and the number as a list. An example of the list output here is illustrated in FIGS. 8A and 8B. FIG. 8A illustrates a list for the first generated result (image 1-1) illustrated in FIG. 4A. The rows of the list represent the objects, and columns represent the name of the image where the object was detected, the object category, the position, and the size. FIG. 8B illustrates a list for the second generated results (image 2-1, image 2-2, and image 2-3) illustrated in FIG. 4B. The rows of the list represent the objects, and columns represent the name of the image where the object was detected, the object category, the position, and the size.

Next, the detection unit 207 aggregates, per category, the number of objects in each of the images of the first generated result and the second generated result on the basis of the object detection result list. In a case where a plurality of images are generated for each generated result, an average of the total detected number for the object per category in these images is taken using the total number of generated images and aggregated in the list as the “number of detected objects”.

FIGS. 8C to 8E are diagrams illustrating an example of the number of objects detected per category. FIG. 8C illustrates the number of objects detected corresponding to the list illustrated in FIG. 8A, and FIG. 8D illustrates the number of objects detected corresponding to the list illustrated in FIG. 8B. In this example, from the one image which is the first generated result, one “frog” and one “mountain” are detected, and from the three images which are the second generated result, an average of one “frog”, an average of 2/3 mountains, and an average of one “pond” are detected.

Note that in the example described here, variation detection is performed using the number of objects detected from the images as the variation item “number of objects”. However, as long as evaluation relating to the number of objects can be performed in a similar manner, the processing is not particularly limited to this example. For example, in a case where a plurality of images are generated as the generated result, the number of images where an object of the corresponding category was detected is calculated, and the detection frequency at which such detection was performed may be treated as the evaluation value of the number of objects. In the case of executing such processing, similarly, in the example illustrated in FIG. 4B, since a mountain is detected in two images of the three images, the evaluation value as illustrated in FIG. 8D is 2/3.

Next, (in S3108) the detection unit 207 determines whether or not there is variation on the basis of these aggregated results. The detection unit 207 calculates the increase or decrease in the number of objects per image for each object category (category c) and determines whether or not there is variation on the basis of this increase/decrease number. In this example, for the category c, the number of objects detected in the first generated result and the second generated result are represented by N1^{c} and N2^{c}, respectively. The detection unit 207 calculates the detection frequency increase/decrease Δ=N2^{c}−N1^{c}, and in a case where M or more of an object category with Δ equal to or greater than a threshold exist, the detection unit 207 determines that there is variation. Here, it is sufficient that the threshold is greater than 0 and M is 1 or greater. However, these values can be set to any values in accordance with desired conditions. FIG. 8E illustrates the Δ value of such variations (in this example, the threshold for the increase/decrease number is 1). As illustrated in FIG. 8E, for the categories “frog” and “mountain”, the Δ is 0. However, for the category “pond”, the Δ is 1, and thus it is determined that there is variation.

As described above, in S3108, the detection unit 207 determines whether or not there is variation on the basis of the variation detection result of S3107. In a case where there is variation, the processing advances to S3109. Otherwise, the processing of FIG. 3A ends.

In S3109, the auxiliary information generation unit 208 generates auxiliary information. As described above, auxiliary information is information including information for changing the input information input into the second model from the first input information. Here, as auxiliary information, information indicating the change policy of the input that assists in how to change the first input information is used in order to obtain a generated result similar to the first generated result when the second model is input with the first input information.

In the examples of FIGS. 4A to 4C, on the basis of the object detection results of FIGS. 8A to 8E, for example, the second generated result is compared with the first generated result, and there is determined to be variation in the output number (generation frequency) for “pond”. Here, the output unit 204, as the input change policy (“prompt change policy” in FIGS. 4A to 4C), an instruction is generated as the auxiliary information for proposing performing input of a positive prompt or a negative prompt relating to the object of the category with variation in the variation item. A (positive) prompt according to the present embodiment is a prompt included in the input to the model for specifying content wished to be included in the generated image when generating an image. Also, a negative prompt according to the present embodiment is a prompt included in the input to the model for specifying content wished to be excluded from the generated image when generating an image using generative AI using a prompt such as Text-to-Image. In this example, a negative prompt is input separately from a positive prompt. For example, in a case where there is a possibility that the object of a category with an increased generation frequency is an unnecessary object for the user, the output unit 204 can generate, as the auxiliary information, an instruction proposing input of a negative prompt for an object.

In the examples of FIGS. 4A to 4C, since the generation frequency of “pond” has increased, a phrase is output saying “With model v2 (post-update model), there is a tendency for a “pond” to be generated more than with model v1 (pre-update model). If this is not required, input “pond” into the negative prompt input field.” Note that for an object with a decreased output number, the user may be presented with an input change policy for adding a phrase in the positive prompt for increasing the number of the object such as “XX landscape” (XX being a name of an object category) and the like. The phrase output here may be fixed text or may be successively generated text but is not limited to such text. Also, for the prompt input, as illustrated in FIG. 4C, on the user interface (UI), separate input may be possible for each prompt type (for example, positive prompt and negative prompt).

Also, in the case of a specific variation item that is known beforehand to be difficult to suppress variation by only changing the text prompt, in response to variation in such a variation item being detected, as the auxiliary information, auxiliary information may be generated to prompt for an addition change of input other than the text prompt. Regarding the positional relationship of the objects (for example, in a case where output is performed so that “generate XX on the right side of YY”, the user may be recommended to specify via BB the generation position of the objects in the image. At this time, the position of the BB may be set on the basis of user input or may be set by the user selecting the object BB from among candidates presented as candidates for the object BB detected from the image.

Also, in a case where there is variation in the position or orientation of an object, as the auxiliary information, information may be generated for prompting the user to specify a reference image (composition image) representing the composition of the image. Also, in a case where there is variation in the style, as the auxiliary information, information may be generated for prompting the user to specify a reference image (style image) to be used in style conversion. In such a case, the output unit 204 can generate the auxiliary information to prompt for the input of a reference image to a (Text+Image)-to-Image model or an Image-to-Image model. In addition, the output unit 204 may generate the auxiliary information to prompt for fine tuning training of the model such as LoRA training using a first generated image generated by the first model. Also, an Image-to-Image model for outputting a reference image (style image or composition image) for reducing the difference between the first generated result and the second generated result used as input may be trained in advance, and then this may be used as the input for a (Text+Image)-to-Image model.

In S3110, the output unit 204 displays the auxiliary information on the display apparatus. The display of the auxiliary information may be performed together with the input information, the model information, or the like. FIG. 4C illustrates an example of a method for presenting the auxiliary information. In the example of FIG. 4C, the first generated result and the second generated result are displayed side-by-side, and the auxiliary information of “With model v2, there is a tendency for a “pond” to be generated more than with model v1 (pre-update model). If this is not required, input “pond” into the negative prompt input field” as described above is displayed. In a case where a plurality of object categories have variation in the output number, as the auxiliary information, which object to increase/decrease the output number of may be presented as an option. In such a case, when the user clicks on the option, a positive prompt or a negative prompt can be input for the selected object. Note that in FIG. 4C, the prompt change policy (auxiliary information) and the prompt input field are displayed on the same screen, but the layout is not limited to such a display. As illustrated in FIG. 4C, by displaying the first generated result and the second generated result together with the auxiliary information, these can be presented to the user in a manner for more easily understanding the intention of the prompt change policy.

In S3111, the reception unit 209 receives an input change from the user and obtains information of the change performed from the first input information as the second input information. Here, the reception unit 209, after the input of auxiliary information on the display of S3110, obtains the change of input information from the user. For example, the reception unit 209 displays a UI for presenting the auxiliary information to the user and for receiving the change content for the first input information and changes the first input information on the basis of the information input on the UI to generate the second input information. Such a UI is illustrated in FIG. 4C, for example. The change of input by the user here may be the input change being confirmed by the press of an input change button with “pond” input into the negative prompt field of FIG. 4C, for example. However, the UI is not limited thereto. The server 103 may display the auxiliary information as text as well as automatically input an input information change example based on the prompt change policy.

In S3112, the second result obtaining unit 206 obtains the third generated result by inputting the second input information obtained in S3111 into the second model.

In S3113, the output unit 204 associates together the third generated result with the generation history information corresponding to the first generated result, and the generation history information is stored by the storage unit 200. Here, as the generation history information, the input information and the model information used in the third generated result is stored. Also, in response to a request from the user, the first generated result, the second generated result, and the third generated result may be presented side-by-side.

Note that in the example described above, the processing of S3103 onward is executed with a model, from among the managed model, with a confirmed change set as the processing target. However, as long as processing using a post-/pre-change model can be executed in a similar manner, no such limitation is intended. For example, a model may be designated in advance as the processing target (for example, as the model having ended the processing of FIG. 3A), and whether or not the model has changed may be confirmed in S3101 to S3102. In a case where there are a plurality of models that are the processing target (for example, a case where update of a plurality of models is confirmed in S3102), subsequent processing is executed separately for each one.

### Effect of First Embodiment

According to such a configuration, a variation in a variation item between the first generated result and the second generated result can be detected, and auxiliary information can be generated for changing the input information to be input into the second model on the basis of the variation. In particular, in a case where the generated result varies for the same input due to a version update of the model, a change policy of input information for obtaining a similar generated result as with before the version update can be presented as the auxiliary information. Accordingly, even in the case of the user using a different model to the model previously used, a generated result similar to the generated result of the previously used model can be easier to obtain.

### Modification Example 1-1

In the first embodiment described above, the number of objects is used as a variation item when there is a version update of the model. In the present modified example described herein, the color of an object is used as the variation item. In the example described below, the detection unit 207 calculates an average value of the hue from pixel values (RGB) of an object region and detects variation per object. However, the evaluation of the detected variation in color is not limited to such as method, and the variation may be detected using the average value of hues of the entire image, for example. Also, as the color, instead of hue, the coordinates in a color space may be used. Here, only the differences from that described above for the first embodiment will be described.

In S3107 according to the present modification example, the detection unit 207 detects variation between the generated results on the basis of the second generated result obtained in S3105 and the first generated result obtained in S3106 and outputs the variation as a variation detection result.

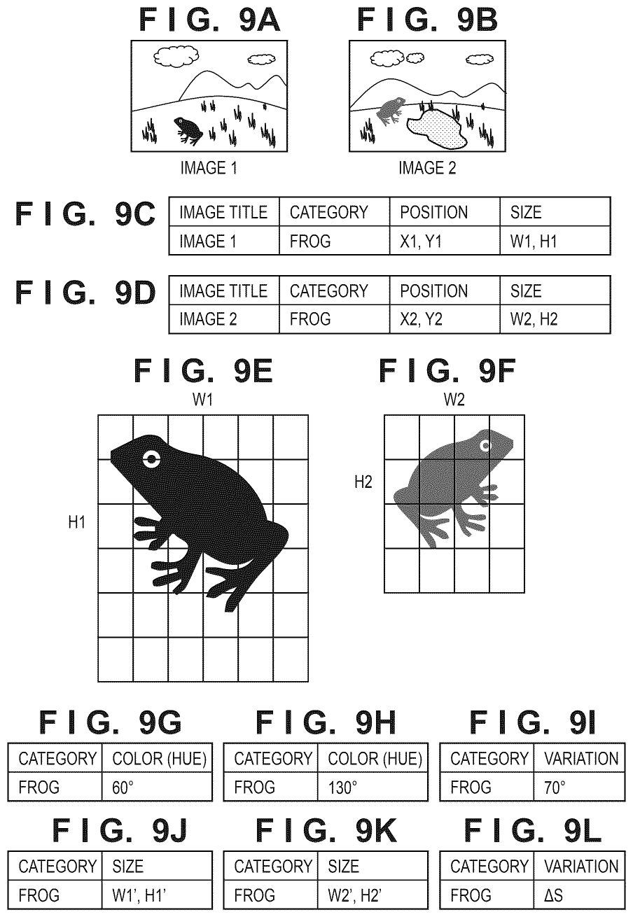

An example in which variation in the color of an object is detected as the variation item will be described below with reference to FIG. 9. FIGS. 9A and 9B illustrate an image 1 corresponding to the first generated result and an image 2 corresponding to the second generated result. The detection unit 207 first uses an object detector to detect objects in the image from each of the first generated result and the second generated result and outputs a list of the object detection results such as illustrated in FIGS. 9C and 9D. In this example, an object region is detected by the object detector and output as the position and size of the BB region surrounding the object. However, the object region detection is not particularly limited thereto, and a known processing may be executed to detect objects in the image. For example, an object region may be identified using a region divider and output as a segmentation mask. FIGS. 9E and 9F illustrate diagrams of an enlarged display of a BB region detected from the first generated result.

Next, for each of the first generated result and the second generated result, the detection unit 207 calculates the hue from the RGB pixel values of each pixel of the object region and calculates an average value Hueₜ of the hue of the entire object region. The Hueₜ calculated in this manner is illustrated in FIG. 9G for the image 1 and FIG. 9H for the image 2. The Hueₜ, for example, can be calculated according to the following Formula (1).

$${Hue}_{t} = \frac{1}{{N}_{t}} {\sum }_{i = 1}^{{N}_{t}} {Hue}_{t}^{i} , where {Hue}_{t}^{i} = arctan ( \frac{\sqrt{3} ( {G}_{t}^{i} - {B}_{t}^{i} )}{2 {R}_{t}^{i} - {G}_{t}^{i} - {B}_{t}^{i}} ) \qquad Formula ( 1 )$$

Here, Nₜ is the number of pixels in the object region and Hueⁱₜ represents the hue calculated from the RGB values of the i-th pixel of an image t. Nₜ may be calculated as the number of pixels (Wₜ×Hₜ) in the bounding box or calculated by counting in order using the pixel in the upper left of the bounding box as i=0, for example, but the calculation method is not particularly limited. In a case where the object region is identified via segmentation, the hue may be calculated for the pixels of the region of the segmentation mask. Also, as in the first embodiment, in a case where a plurality of objects of the same category are detected, the average value for one hue per category in each image may be calculated by further taking the average value for Hueₜ calculated for each object.

In S3108, the detection unit 207 determines whether or not there is variation on the basis of the aggregated result. Here, the detection unit 207 calculates, for each object category, a difference ΔHue between the average values Hue₁ and Hue₂ of a hue of both objects of the same category detected in the first generated result and the second generated result, and in a case where M or more object categories with the difference ΔHue equal to or greater than the threshold exist, the detection unit 207 determines there to be variation. Here, it is sufficient that the threshold is greater than 0 and M is 1 or greater. However, these values can be set to any values in accordance with desired conditions. FIG. 9I illustrates the value of the ΔHue of such a variation (in this example, the threshold for hue difference is) 60°. In FIG. 9I, since the ΔHue indicating the hue variation is 70°, which is equal to or greater than the threshold, it is determined that there is variation.

Note that as in the first embodiment, in a case where a plurality of objects of the same category are detected, the hue variation may be calculated only for object regions detected at nearby coordinates in the first generated result and the second generated result. Detection at nearby coordinates or not may be calculated via Intersection over Union of the BB's which are the object detection results or the like.

In S3109, the auxiliary information generation unit 208 generates auxiliary information. In the present modification example, since color variation is detected as the variation item, auxiliary information to reduce the color variation is generated. Here, as the auxiliary information, for example, information prompting the user to add a phrase specifying a color in the prompt may be generated or information prompting the user to change (correct) a prompt relating to color may be generated. For example, in the example of FIGS. 9A to 9L, a variation in the color of the frog is detected. Thus, auxiliary information may be generated saying “In the generated images of model v2 and model v1, variation in the color of the “frog” has been detected. Please add a phrase specifying the color of the frog.”

### Effect of Modification Example 1-1

According to such a configuration, a variation in color between the first generated result and the second generated result can be detected, and auxiliary information can be generated for changing the input information to be input into the second model on the basis of the variation. Accordingly, even in the case of the user using a different model to the model previously used, a generated result including color similar to the generated result of the previously used model can be easier to obtain.

### Modification Example 1-2

In Modification Example 1-1 described above, the color of an object is used as the variation item. In the present modified example described herein, the position and size of an object is used as the variation item. The position and size of an object affects the composition of an image. Thus, by the server 103 prompting the user to change the prompt to reduce variation in the position and size of an object, the user can more easily obtain a generated result with less variation in the composition of the image as a result. Here, only the differences from that described above for the first embodiment will be described.

In S3107, as in Modification Example 1-1, the detection unit 207 detects variation between the generated results on the basis of the second generated result obtained in S3105 and the first generated result obtained in S3106 and outputs the variation as a variation detection result.

As in Modification Example 1-1, an example in which variation in the size of an object is detected as the variation item will be described below with reference to FIGS. 9A to 9L. As in Modification Example 1-1, the detection unit 207 first uses an object detector to detect objects in the image from each of the first generated result and the second generated result and outputs a list of the object detection results such as illustrated in FIGS. 9C and 9D. In this example, an object region is detected by the object detector and output as the position and size of the BB region surrounding the object.

Next, the detection unit 207 aggregates the average value (Wₜ′, Hₜ′) of the size of the object per category for each of the first generated result and the second generated result. In the example of FIGS. 9C and 9D, there is one category of detected objects (only frog) and there is one object detected for that category in all of the generated results. Thus, calculation of the average value is unnecessary, and (Wₜ′, Hₜ′)=(Wₜ, Hₜ).

FIGS. 9J to 9L illustrate an example of an aggregate result calculated in this manner. FIG. 9J illustrates that the average value of the size of the frog in the first generated result is (W₁′, H₁′), and FIG. 9K illustrates that the average value of the size of the frog in the second generated result is (W₂′, H₂′). The detection unit 207 calculates a variation ΔS of the size of the object between the first generated result and the second generated result per object category on the basis of these aggregate results. ΔS can be calculated according to the following Formula (2), for example. ΔS calculated via the following Formula (2) represents an object area ratio between the first generated result and the second generated result.

$$Δ S = \frac{( {W}_{2} \times {H}_{2} )}{( {W}_{1} \times {H}_{1} )} \qquad Formula ( 2 )$$

In S3108, the detection unit 207 determines whether or not there is variation on the basis of the aggregated result. Here, per object category, in a case where M or more of an object category with ΔS equal to or greater than a threshold exists, the detection unit 207 determines that there is variation. In a case where (W1′, 1′)=(120, 120), (W2′, H2′)=(80, 80), for the object category “frog”, ΔS is 2/3. Thus, in a case where the threshold is 0.5, it is determined that there is variation. Note that as in the first embodiment, in a case where a plurality of objects of the same category are detected, the size variation may be calculated only for object regions detected at nearby coordinates in the first generated result and the second generated result.

In S3109, the auxiliary information generation unit 208 generates auxiliary information. In the present modification example, since size variation is detected as the variation item, auxiliary information to reduce the size variation is generated. Here, as the auxiliary information, for example, information prompting the user to add a phrase specifying a size in the prompt may be generated or information prompting the user to change a prompt relating to size may be generated. For example, in the example of FIGS. 9A to 9L, a variation in the size of the frog is detected. Thus, auxiliary information may be generated saying “In the generated images of model v2 and model v1, variation in the size of the “frog” has been detected. Please add a phrase specifying the size of the frog.” Note that in the example described here, size variation is used as the variation item. However, variation in the position (X, Y) of the object may be calculated as the variation item, and in a case where the variation is greater than a threshold, the user may be prompted to add a prompt for reducing the variation.

### Effect of Modification Example 1-2

According to such a configuration, a variation in position and size of an object between the first generated result and the second generated result can be detected, and auxiliary information can be generated for changing the input information to be input into the second model on the basis of the variation. Accordingly, even in the case of the user using a different model to the model previously used, a generated result including position and size similar to the generated result of the previously used model and with less variation in the composition of the image can be easier to obtain.

### Second Embodiment

The server 103 according to the second embodiment can execute processing similar to that of the server 103 according to the first embodiment. Also, the server 103 according to the second embodiment evaluates the variation width of the generated result in a case where the input into the second model has changed from the first input information to the second input information and displays information for changing the input information again in a case where the variation width is greater than a predetermined threshold.

The system including the server 103 according to the present embodiment has the hardware configuration illustrated in FIGS. 1A to 1C similarly to the first embodiment, and as similar processing can be executed, redundant descriptions will be omitted.

The server 103 according to the present embodiment includes a storage unit 500, a model management unit 501, a control unit 502, an obtaining unit 503, a first result obtaining unit 504, a second result obtaining unit 505, a variation width evaluation unit 506, a detection unit 507, an auxiliary information generation unit 508, an output unit 509, and a reception unit 510. Of these, the storage unit 500 can execute similar processing to the storage unit 200 according to the first embodiment, and the same applies to the model management unit 501 and the model management unit 201, the obtaining unit 503 and the obtaining unit 202, the first result obtaining unit 504 and the first result obtaining unit 203. Thus, redundant descriptions will be omitted. Also, the second result obtaining unit 505 can execute similar processing to the second result obtaining unit 206, the auxiliary information generation unit 508 can execute similar processing to the auxiliary information generation unit 208, and the reception unit 510 can execute similar processing to the reception unit 209. Thus, redundant descriptions will be omitted.

The functional units different from those in the first embodiment from among the functional units of the server 103 will be described below. The control unit 502 controls the operations of the obtaining unit 503 and the detection unit 507 on the basis of the model management information managed by the model management unit 501 and the variation width evaluated by the variation width evaluation unit 506.

The variation width evaluation unit 506 performs an evaluation of whether or not there is variation between two generated results. The evaluation of whether or not there is variation between two generated results by the variation width evaluation unit 506 can be executed in a similar manner to the processing executed in S3108 by the detection unit 507 according to the first embodiment. The two generated results used here may be the first generated result and the second generated result or may be the first generated result and the third generated result.

The detection unit 507 detects variation between the two generated results on the basis of the variation width evaluated by the variation width evaluation unit 506.

The output unit 509 outputs the first generated result, the second generated result, and the third generated result as the generation history information, and this output is stored by the storage unit 500. Also, the output unit 509 may output the generated result, generation history information, or the like to a display apparatus such as the display unit 101-7. The output unit 509 outputs the auxiliary information and presents it to the user. In the present embodiment, the auxiliary information output in a similar manner to the first embodiment is expressed as “first auxiliary information” to differentiated it from second auxiliary information described below. Also, the output unit 509 can generate the second auxiliary information for prompting the user to change the second input information again on the basis of the variation width evaluated by the variation width evaluation unit 506 on the basis of the first generated result and the third generated result.

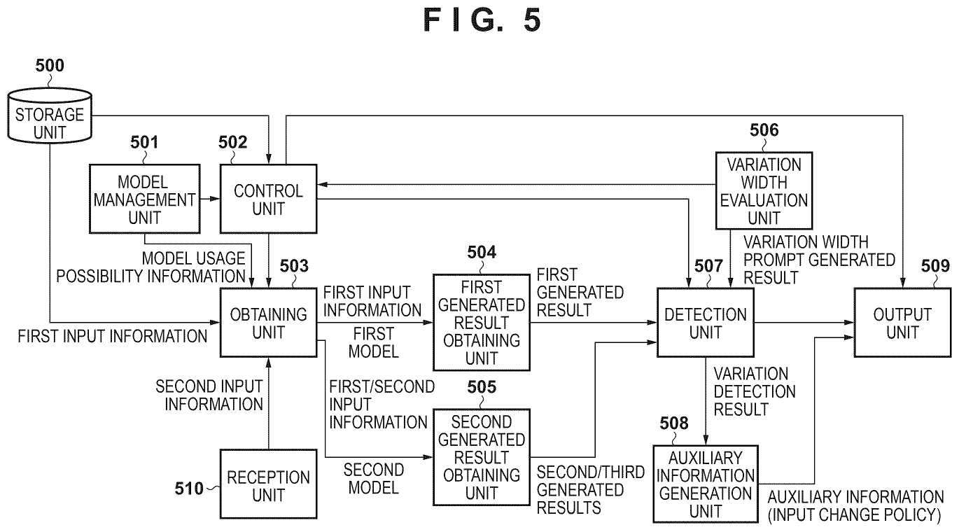

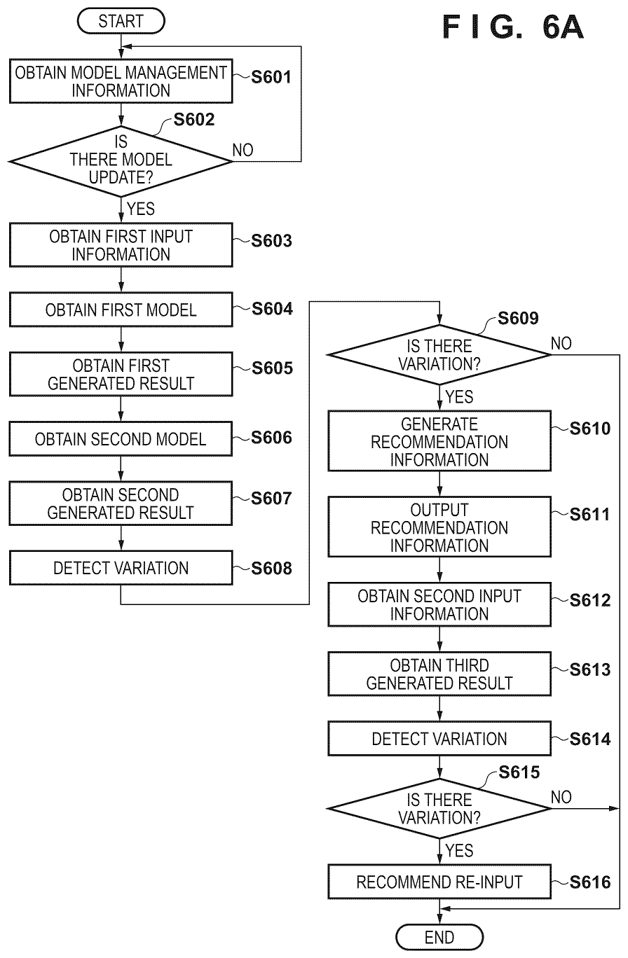

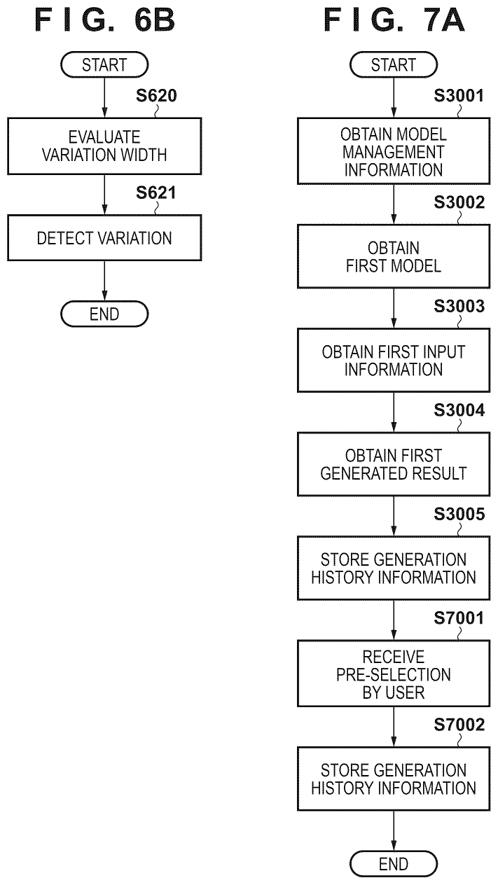

FIG. 6A is a flowchart illustrating the flow of the entire processing according to the present embodiment. In the present embodiment, as in the first embodiment, variation between the first generated result and the second generated result when the version of the model is updated is calculated. Also, in the first embodiment described above, the first generated result uses that stored by the storage unit 500. However, if the number of users or pieces of generation history information increases, a very large memory capacity would be required for storage processing by the storage unit 500. From this perspective, in the present embodiment, first generated result generation processing using the first model is executed again when the version of the model is updated. This can reduce the memory capacity.

In S601, the obtaining unit 503 obtains model management information for each model as in S3101.

In S602, the obtaining unit 503 confirms whether or not there is a model with an update as in S3102. In a case where a model has been updated, the processing advances to S603. Otherwise, the processing returns to S601.

In S603, the obtaining unit 503 obtains generation history information including the first input information with the model being updated as the processing target.

In S604, the obtaining unit 503 obtains the first model, which is the pre-update model of the processing target model. In S605, the first result obtaining unit 504 obtains the first generated result by inputting the first input information obtained in S603 into the first model.

In S606, the obtaining unit 503 obtains the model which is the processing target being updated as the second model. In S607, the second result obtaining unit 505 obtains the second generated result obtained by inputting the first input information obtained in S603 into the second model.

In S608, the detection unit 507 detects variation between the first generated result obtained in S605 and the second generated result obtained in S607 and outputs this as the variation detection result. The processing executed in S608 according to the present embodiment will now be described with reference to FIGS. 8C to 8E. Note that in the example described here, variation in the color of an object constituting the image is detected as the variation item. However, a different item such as the number, size, or position of an object or the like may be used as the variation item.

The process illustrated in FIGS. 8C to 8E will now be described. First, in S620, the variation width evaluation unit 506 performs evaluation of the variation width between the two generated results. For example, the variation width evaluation unit 506 can calculate a difference ΔHue in the hue from Modification Example 1 and can evaluates the ΔHue as the variation width. In the example of FIG. 9I, the ΔHue is 70°.

Next, in S621, the variation width evaluation unit 506 performs variation detection according to the variation width evaluated in S620 and outputs the variation detection result. Then, the processing advances to S609. Here, as in the processing by the detection unit 207 in S3107 of the first embodiment, the variation width evaluation unit 506 can determine that there is variation in a case where the variation width is greater than a predetermined threshold.

In S609, the variation width evaluation unit 506 determines whether or not there is variation on the basis of the variation detection result obtained in S608. In a case where there is variation, the processing advances to S610. Otherwise, the processing of FIG. 6A ends. The processing of S609 can be executed in a similar manner as in S3108 of the first embodiment.

In S610, the auxiliary information generation unit 508 generates the first auxiliary information in a similar manner as in S3109. For example, in a case where the color of a generated bear has changed, as the first auxiliary information, auxiliary information for prompting the user to change the prompt to fill in the blank of “a XX colored bear”, for example, may generated, and the user may be caused to input the XX.

In S611, the output unit 509 displays the first auxiliary information on the display apparatus in a similar manner as in S3110.

In S612, the reception unit 510 receives a change in input by the user as in S3111 and obtains the second input information. Here, the first auxiliary information filling in the blank of “a XX colored bear” in S610, for example, is generated, and input to fill in XX can be obtained from the user.

In S613, the second result obtaining unit 505 obtains the third generated result by inputting the second input information into the second model as in S3112.

In S614, the detection unit 507 using the first generated result and the third generated result and detects variation using a process similar to that of S608 and outputs the variation detection result.

In S615, the variation width evaluation unit 506 determines whether or not there is variation on the basis of the variation detection result obtained in S614. In a case where there is variation, the processing advances to S616. Otherwise, the processing of FIG. 6A ends. The processing of S615 can be executed in a similar manner as in S609 except that instead of the second generated result, the third generated result is used as the generated result to be used. Also, the output unit 509 may present the third generated result to the user, and the storage unit 500 may be stored the third generated result in association with the generation history information corresponding to the first generated result. Here, as the generation history information, the input information and the model information used in the third generated result is stored.

In S616, the auxiliary information generation unit 508 generates information prompting the user to change and re-input the second input information as the second auxiliary information. Here, the second auxiliary information is generated in a similar manner to the first auxiliary information and is information including information for changing the input information input into the second model from the second input information. The second auxiliary information is generated via processing similar to that of the first auxiliary information, but is a text prompt with a different phrase from the first auxiliary information.

Here, consider an example in which the auxiliary information generation unit 508 presents to the user a text prompt with a blank space XXX such as “a XX colored bear” as the first auxiliary information and a prompt corresponding to the second input information is generated by obtaining an input to fill in the blank space XX from the user. In this case, the auxiliary information generation unit 508 can generate, as the second auxiliary information, auxiliary information with a different phrase from the first auxiliary information that is auxiliary information for changing the variation item in a similar manner to the first auxiliary information such as “a bear that is colored XX” or “a XX bear” with the blank space XX filled in. Here, the auxiliary information generation unit 508 can generate as the second auxiliary information, from among a plurality of candidates of the second auxiliary information with a blank space such as that described above, a candidate (or a plurality of candidates in order to greatest variation amount) that can be evaluated to be able to decrease the variation amount the most when actually set as the second auxiliary information. For example, the auxiliary information generation unit 508 can generate, as the second auxiliary information, from among the candidates described above, a candidate evaluated to decrease the variation amount from the first generated result the most of a fourth generated result output by inputting into the second model the third input information with the blank space filled in using the blank content used (obtained in S612) when generating the second input information. The phrase of the auxiliary information with the blank spaces filled in may be prepared in advance or may be estimate via LLM or the like. For example, an image description generation model or the like may be trained, an editing instruction prompt for filling in the difference from the two generated images (features) may be deduced, and then this may be used as the auxiliary information phrase. Also, the auxiliary information generation unit 508 may generate a fill-in-the-blank phrase with an adjective added such as “a deep XX color”, “light XX color”, or the like as the auxiliary information depending on the variation amount. Also, from among the candidates of the second auxiliary information, only a candidate with a variation amount when actually set as the second auxiliary information that is equal to or greater than a threshold may be recommended as the second auxiliary information.

### Effect of Second Embodiment

In this manner, evaluation of the variation amount of each candidate of the auxiliary information can be performed, and the second auxiliary information can be generated with expectations of a good effect in reducing the variation (for example, in order of expected good effect). Accordingly, even in the case of the user using a different model to the model previously used, a generated result similar to the generated result of the previously used model can be even easier to obtain. Also, because the auxiliary information is generated and presented to the user in order of the expected good effect as described above, auxiliary information that makes it even easier for the user to select an input change can be generated.

### Third Embodiment

If variation detection is performed in conjunction with a model update for all of the generation history information, which are sets of a prompt, model, and generated result, and processing is executed to generate auxiliary information, there is a possibility of a high load being applied to the system. From this perspective, the server 103 according to the present embodiment limits the first generated results, of the first generated results of the models managed by the model management information, to be the processing target according to a predetermined criteria. Accordingly, in a case where there is a large number of pieces of generation history information, the load on the server can be reduced and the labor performed by the user to change the prompt can be reduced. The server 103 according to the third embodiment can execute processing similar to that of the server 103 according to the first embodiment. Thus, redundant descriptions will be omitted.

The system including the server 103 according to the present embodiment has the hardware configuration illustrated in FIGS. 1A to 1C similarly to the first embodiment, and as similar processing can be executed, redundant descriptions will be omitted. Also, the server 103 according to the present embodiment includes the functional units illustrated in FIGS. 2A and 2B similarly to the first embodiment, and as similar processing can be executed, redundant descriptions will be omitted.

As described above, the server 103 according to the present embodiment limits the plurality of models to models that are processing targets that satisfy a predetermined criteria. Here, the predetermined criteria may be, for example, being pre-selected by the user (described below in detail), a frequency of use being equal to or greater than a predetermined threshold, a variation being previously detected, the size of the variation (variation width) being equal to or greater than a certain value, or the like. In the example described below, being pre-selected by the user is used as the predetermined criteria.

Note that here, “frequency of use” described above indicates how frequent the generation processing is executed by the user using the model. This frequency may be the number of times the generation processing has been executed in a predetermined time period or may be the number of times the user has selected the model to be used in a predetermined time period.

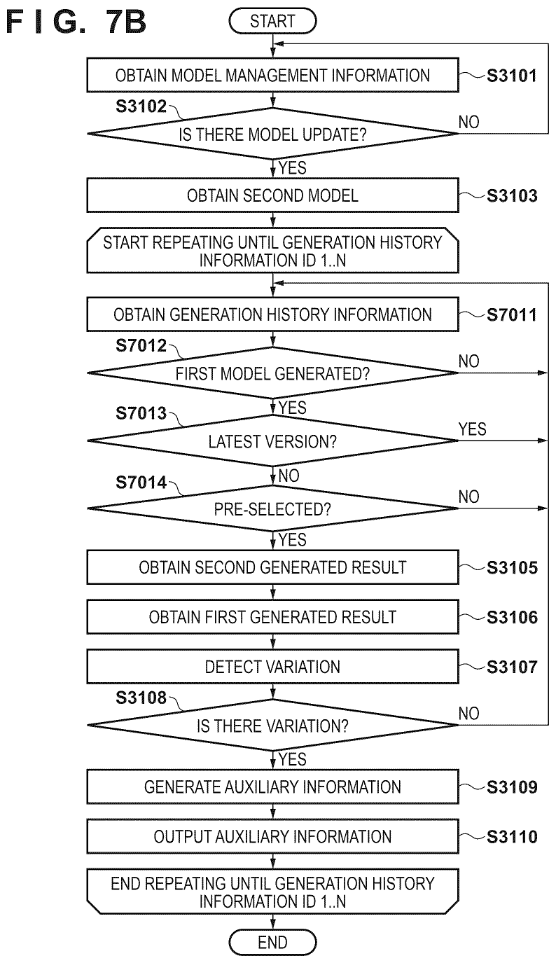

An example of the information processing executed by the server 103 according to the present embodiment will be described below with reference to FIGS. 7A and 7B. The processing illustrated in FIGS. 7A and 7B is an example, and all of the processing described using the flowchart is not necessarily executed by the server 103. The flowchart of FIG. 7A illustrates the processing (first image generation processing (a)) by the first model, and the flowchart of FIG. 7B illustrates the processing (second image generation processing (b)) by the second model.

### Processing by First Model

FIG. 7A is a flowchart illustrating an example of the processing in a case where the first image generation processing (a) is executed using the first model according to the present embodiment. The processing illustrated in FIG. 7A is similar to that illustrated in FIG. 3A of the first embodiment except that S7001 and S7002 are executed after S3005. Thus, redundant descriptions will be omitted.

In S7001, the reception unit 209 receives a pre-selection on the basis of the first model obtained in S3004. For example, in S7001, the generated result or generation history information from the output unit 204 may be presented to the user using the display apparatus 101-7, and the reception unit 209 may receive a pre-selection for the generated result (or generation history information). Here, the purpose of the pre-selection is for prioritizing execution of the variation detection processing when there is a model version update and the generation processing of the auxiliary information in the subsequent processing for the selected generation history information.

The detailed processing actually executed in S7001 includes the output unit 204 presenting to the user the generated result or the generation history information by displaying it on the display apparatus 101-7. Next, from the perspective of confirming the generated result or the generation history information and see whether or not the user wishes to re-generate an image of similar taste, the user determines whether or not to prioritize variation detection processing and inputs the pre-selection. The determination method may include, for example, presenting a checkbox for designating whether or not to prioritize performing variation detection on a touch panel and receiving a user designation via an input to the checkbox. The generated result or the generation history information presented here may be the first generated result or the generation history information stored in S3005, and previous generated results or generation history information may be displayed side-by-side on a touch panel for the user to select a plurality of options.

In S7002, the storage unit 200 includes the information of a pre-selection flag indicating whether there was a pre-selection in the generation history information and stores the generation history information on the basis of the pre-selection received in S7001. The value of the pre-selection flag is set to True if there was a pre-selection and set to False if there was not. Also, in a case where the user selects a plurality of pieces of generation history information from the previous generation history information, the pre-selection flag is updated for these pieces of generation history information.

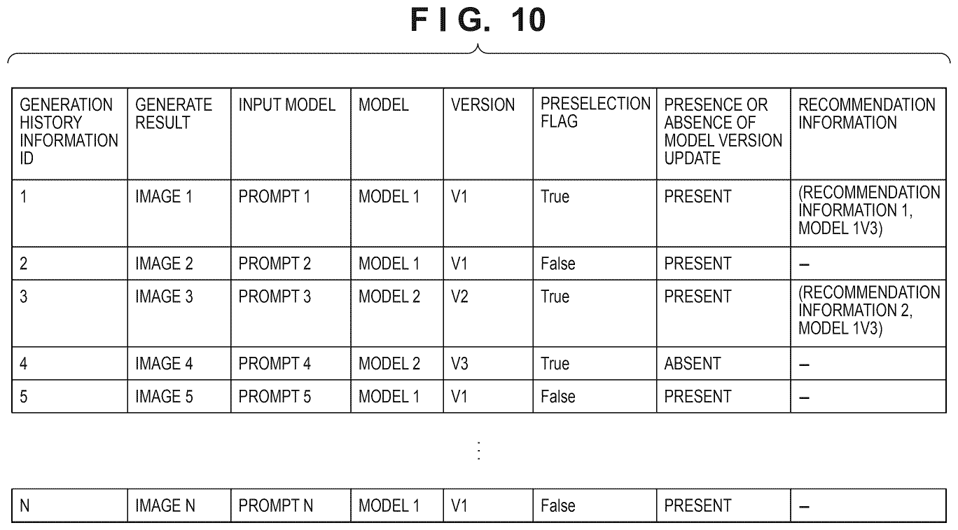

S3001 to S7002 illustrated in FIG. 7A are executed each time an image is generated using the first model, and the storage unit 200 collects the generation history information. An example of a database of the generation history information stored by the storage unit 200 is illustrated in FIG. 10. In this example, one piece of generation history information is stored on each row in a table format. The columns of each generation history information include the generation history information ID, the generated result data and input (prompt) to the model used in the generation, the model type, the model version, the pre-selection flag indicated whether or not there was a pre-selection, and auxiliary information. For example, for the generation history information ID1, it is indicated that image 1 generated using v1 (version 1) of model 1 with prompt 1 is stored and the user has performed a pre-selection in S7002. As the generation history information, the generation date and time and the like may also be stored, and the information stored here is not particularly limited. Also, it is expected that there are various types of models (for example, model 1, model 2, and model 3) and a user selects a model to use. It is also expected that version updates are performed for the models.

Also, here in S3005, the first generated result is stored as the generation history information, but the first generated result may be stored as the same timing as when the information of the pre-selection flag is set in S7002. Also, here, pre-selection is performed for each first generated result. However, for example, a pre-selection may be received for the first model when it is the target to execute the processing of S3002 to S3005, and the generated results from the first model may all be the pre-selections received.

### Processing by Second Model

In the present processing, when the version of the first model is updated, from among the generation history information stored in the database, information that satisfies a condition is extracted. The condition is that the first model is used, an old version is used, and pre-selection has been performed. The condition is also that a first prompt is input to the second model, which is a model with a version update, and the second generated result is output. The condition is also that variation detection is performed between the first generated result and the second generated result, and auxiliary information is generated if there is variation. In the example of FIG. 10, at the time of updating the version of the model 1, which is the first model, to V3, variation detection is performed for the generation history using V1 and V2, which are older models that V3.

FIG. 7B is a flowchart illustrating an example of the processing in a case where the second image generation processing (b) is executed using the second model according to the present embodiment. The processing illustrated in FIG. 7B is executed in a similar manner as that illustrated in FIG. 3B of the first embodiment except that S7011 to S7014 are executed instead of S3104 and the processing of S3111 onward is omitted. Thus, redundant descriptions will be omitted.

In the processing illustrated in FIG. 7B, after executing S3101 to S3103 of FIG. 3B, S7011 to S3110 is repeatedly executed from generation history information ID=1 to ID=N of the generation history information database stored by the storage unit 200. In the processing loop of S7011 to S3108, the detection unit 207 detects variation between the first generated result and the second generated result and outputs this as the variation detection result. The variation detection is performed on only the generation history information that used the first model and has a pre-selection (limited as the processing target).

In S7011, the detection unit 207 obtains one piece of generation history information stored by the storage unit 200 as the processing target. Here, if the total number of obtained generation history information is N, each piece of generation history information is allocated in order of being obtained with an ID from 1 to N. In the loop processing of S7011 to S3110, in S7011, the generation history information is obtained as the processing target in order from the smallest ID. Note that there, the detection unit 207 may provide a maximum value and not obtain all of the generation history information to reduce the processing load. In this case, the detection unit 207 may obtain the generation history information in order from newest generation history information (newest associated date and time) from the perspective of restricting the generation history information to obtain to only the pieces with a high possibility of being reused by the user.

In S7012, the detection unit 207 determines whether or not the generation history information which is the processing target was generated using the first model. In a case where the generation history information which is the processing target was generated using the first model, the processing advances to S7013. Otherwise, the processing advances to S7011. For example, in the case of using the database of the generation history information illustrated in FIG. 10 and the first model is the model 1, the generation history information with model 1 for the model is extracted from the database.

In S7013, the detection unit 207 determines whether or not the version of the model associated with the generation history information which is the processing target is the latest version. In a case where the version of the model associated with the generation history information which is the processing target is the latest version, the processing advances to S7014. Otherwise, the processing advances to S7011. In this example, in a case where the version of the model associated with the generation history information is not V3, the processing advances to S7014.

In S7014, the detection unit 207 determines whether or not the value of the pre-selection flag associated with the generation history information which is the processing target is True (pre-selection has been performed). In a case where the value of the pre-selection flag associated with the generation history information which is the processing target is True, the processing advances to S3105. Otherwise, the processing returns to S7011.

Next, processing similar to the processing from S3105 to S3110 in the first embodiment is executed on the generation history information obtained in S7011. In a case where variation is not detected in S3108, the processing returns to S7011. In a case where variation is detected in S3108, auxiliary information is generated in S3109 to S3110, and after this is stored in the database of the generation history information, the processing returns to S7011. The auxiliary information also records which version was used in generation. In FIG. 10, for generation history information ID1, auxiliary information is generated and recorded indicating that the model 1 was version updated from V1 to V3.

The processing up until here in FIG. 7B is executed when the version of the model is updated. The output processing of the third generated result using the auxiliary information from S3111 to S3113 in the first embodiment is executed at any timing at the discretion of the user.

### Effect of Third Embodiment

According to this configuration, the generation history information is restricted to a target for variation detection. Thus, even in the case of a large amount of generation history information, the load on the server can be reduced. Also, the labor by the user to change the prompt can also be reduced.

Even in the case of the user using a different model to the model previously used, a generated result similar to the generated result of the previously used model is easier to obtain.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-193959, filed Nov. 5, 2024 which is hereby incorporated by reference herein in its entirety.

What is claimed is:

1. An information processing apparatus comprising:
a first obtaining unit configured to obtain a first generated result via input of first input information into a first machine learning model;
a second obtaining unit configured to obtain a second generated result via input of the first input information into a second machine learning model different from the first machine learning model;
a detecting unit configured to detect a first variation of an item that varies depending on a difference in machine learning models used in generation between the first generated result and the second generated result; and
a first generation unit configured to generate, based on the first variation, first auxiliary information including information for changing input information to be input into the second machine learning model from the first input information in a case where the first variation is detected.

2. The information processing apparatus according to claim 1, wherein
the second obtaining unit further obtains a third generated result via input of second input information different from the first input information into the second machine learning model.

3. The information processing apparatus according to claim 1, further comprising:
a presenting unit configured to present the first auxiliary information to a user;
a third obtaining unit configured to obtain user input in conjunction with the first auxiliary information being presented to a user; and
a second generation unit configured to generate second input information by changing the first input information, based on the user input.

4. The information processing apparatus according to claim 1, wherein
the first generation unit generates the first auxiliary information so that a second variation of the item between the first generated result and a third generated result obtained via input of second input information obtained by changing the first input information based on the first auxiliary information into the second machine learning model is less than the first variation.

5. The information processing apparatus according to claim 4, wherein
the first auxiliary information is text information prompting for reducing the first variation.

6. The information processing apparatus according to claim 5, wherein
the first input information includes a text prompt, and
the first auxiliary information is information prompting for correcting the text prompt.

7. The information processing apparatus according to claim 1, further comprising:
an evaluating unit configured to evaluate a variation width of the first variation, wherein
the detecting unit performs detection of the first variation, based on an evaluation of a variation width of the first variation.

8. The information processing apparatus according to claim 7, wherein
the evaluating unit further evaluates the variation width of a second variation of the item between the first generated result and a third generated result obtained via input of second input information different from the first input information into the second machine learning model,
the detecting unit further detects the second variation, based on an evaluation of a variation width of the second variation, and
the first generation unit further generates second auxiliary information including information for changing input information to be input into the second machine learning model from the second input information in a case where the second variation is detected.

9. The information processing apparatus according to claim 8, wherein
the first auxiliary information is text information prompting for reducing the first variation, and
the second auxiliary information is text information different from the first auxiliary information prompting for reducing the first variation.

10. The information processing apparatus according to claim 9, wherein
the first generation unit generates a plurality of pieces of the second auxiliary information,
the evaluating unit further evaluates a variation width of a third variation of the item between the second generated result and a fourth generated result obtained via input of third input information obtained by changing the second input information based on the second auxiliary information into the second machine learning model, for each one of the plurality of pieces of the second auxiliary information, and
the plurality of pieces of the second auxiliary information are presented in order that is based on a variation width of the third variation.

11. The information processing apparatus according to claim 1, wherein
the first obtaining unit obtains the first generated result from each one of a plurality of machine learning models, and
the detecting unit detects the first variation of the item between the first generated result and the second generated result for only the first generated result that satisfies a predetermined condition.

12. The information processing apparatus according to claim 11, wherein
the predetermined condition is being selected in advance by a user.

13. The information processing apparatus according to claim 11, wherein
the predetermined condition is a frequency of use by a user of a machine learning model for generating a corresponding first generated result being equal to or greater than a predetermined threshold.

14. The information processing apparatus according to claim 11, wherein
the predetermined condition is a first generated result in which a first variation of an item has been detected with the second generated result by the detecting unit or a first generated result in which a magnitude of a first variation of an item with the second generated result is equal to or greater than a predetermined threshold.

15. The information processing apparatus according to claim 1, further comprising:
a managing unit configured to manage information indicating whether a plurality of machine learning models can be used by a user, wherein
the first machine learning model is, from among the plurality of machine learning models, a machine learning model that the user has been allowed to use by the managing unit.

16. The information processing apparatus according to claim 1, wherein
the first generated result and the second generated result are image data, and
the item is a number of a specific object, a color of the specific object, a position of the specific object, or a size of the specific object in the first generated result and the second generated result.

17. An information processing method comprising:
obtaining a first generated result via input of first input information into a first machine learning model;
obtaining a second generated result via input of the first input information into a second machine learning model different from the first machine learning model;
detecting a first variation of an item that varies depending on a difference in machine learning models used in generation between the first generated result and the second generated result; and
generating, based on the first variation, first auxiliary information including information for changing input information to be input into the second machine learning model from the first input information in a case where the first variation is detected.

18. A non-transitory computer-readable storage medium configured to store a computer program comprising instructions for executing following processes:
obtaining a first generated result via input of first input information into a first machine learning model;
obtaining a second generated result via input of the first input information into a second machine learning model different from the first machine learning model;
detecting a first variation of an item that varies depending on a difference in machine learning models used in generation between the first generated result and the second generated result; and
generating, based on the first variation, first auxiliary information including information for changing input information to be input into the second machine learning model from the first input information in a case where the first variation is detected.
